(19) United States
(12) Patent Application Publication
(10) Pub. No.: US 2005/0229246 A1
(43) Pub. Date: Oct. 13, 2005

(54) Programmable context aware firewall with integrated intrusion detection system

(76) Inventors: Priya Rajagopal, Hillsboro, OR (US); Ravi Sahita, Beaverton, OR (US); Pankaj N. Parmar, Beaverton, OR (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/815,539

(22) Filed: Mar. 31, 2004

(51) Int. Cl. H04L 9/00; H04L 9/32; G06F 11/30; G06F 12/14

(52) U.S. Cl. 726/14

(57) ABSTRACT

A context-aware firewall and intrusion detection system receives a definition of a Protocol State Machine (PSM) that defines the expected behavior of any protocol (FTP, HTTP, etc.). The PSM provides rules for detecting flows that deviate from the defined protocol behavior and taking appropriate actions. PSMs are comprised of rule groups define behavior of a protocol. The rules include conditions and actions that may be executed if the conditions are satisfied, The actions include dynamically adding filters to be applied to the network flow, saving results for use in later executed rules, and activating and deactivating rules. Thus, these firewalls are capable of selective and intelligent Processing based on flow state information and control payload.

### FIELD

Embodiments of the present invention relate generally to network security devices, and more particularly to programmable context aware firewalls.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2004, Intel Corporation. All Rights Reserved.

### BACKGROUND

A firewall is a software or hardware entity that inspects traffic passing between a trusted and an un-trusted side. The trusted side may be a single node or a network. The firewall checks the traffic against an ordered set of access control rules on traffic coming into the trusted side and another on traffic leaving the trusted side of the network. Different rules are typically applied to ingress and egress traffic. Actions are applied to traffic that matches associated rules. Default catch-all deny, accept or other action is applied to traffic that does not match any configured rules.

Firewalls that exist today are typically one of the following types: simple packet based filters, simple stateful firewalls, and application level gateways. Simple packet based filters typically compare fields in the packet header to a set of criteria before it is forwarded or dropped. Packet filters have the advantage of being low cost and have a low impact on network throughput. However, they do not perform any stateful packet inspection and are generally insufficient to deal with the complex application level attacks common today. The second type includes simple stateful firewalls that do network layer stateful packet processing such as validating the TCP 3-way handshake between client and server, monitoring ICMP echo request response pairs and so on. These firewalls also typically do not do any intelligent processing of application layer data and thus can only thwart a small fraction of network attacks. However, they do not significantly impact the network throughput. The third type includes Application Level Gateways (or Proxies) which proxy client-server connections and perform application layer packet inspection, however, proxies typically have several disadvantages. These disadvantages include a significant impact on network throughput, the need for a proxy to be implemented for every service that needs to be protected and the violation of the Internet's end-to-end principle.

Additionally, the complexity of network based security attacks continues to increase. Current firewall systems generally lack integrated intrusion detection capability to match the complexity of such security attacks.

In view of the above, there is a need for the present invention.

### BRIEF DESCRIPTION OF THE DRAWINGS

FIG. 1 is a block diagram illustrating an overview of a system incorporating embodiments of the invention.

FIG. 2 illustrates an exemplary protocol state machine according to embodiments of the invention.

FIG. 3 is an illustration of an exemplary PSM having three rules according to an embodiment of the invention.

FIG. 4 is a block diagram illustrating a data structure for a binary format for a PSM rule according to embodiments of the invention.

FIG. 5 illustrates an example how a rule data structure is used during the execution of a rule.

FIG. 6 illustrates the operation of a firewall according to an embodiment of the invention for an exemplary AFTP (Active File Transfer Protocol) session.

FIG. 7 is a flowchart illustrating methods providing a context aware firewall according to embodiments of the invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the various embodiments of the invention, and it is to be understood that other embodiments may be utilized and that logical, mechanical, electrical and other changes may be made without departing from the scope of the present invention. The following detailed description is, therefore, not to be taken in a limiting sense.

In the Figures, the same reference number is used throughout to refer to an identical component which appears in multiple Figures. Signals and connections may be referred to by the same reference number or label, and the actual meaning will be clear from its use in the context of the description. Further, the same base reference number (e.g. 120) is used in the specification and figures when generically referring to the actions or characteristics of a group of identical components. A numeric index introduced by a decimal point (e.g. 120.1) is used when a specific component among the group of identical components performs an action or has a characteristic.

The detailed description is divided into multiple sections. In the first section the hardware and software operating environment of different embodiments of the invention are described. In the second section methods according to various embodiments of the invention are described.

### Operating Environment

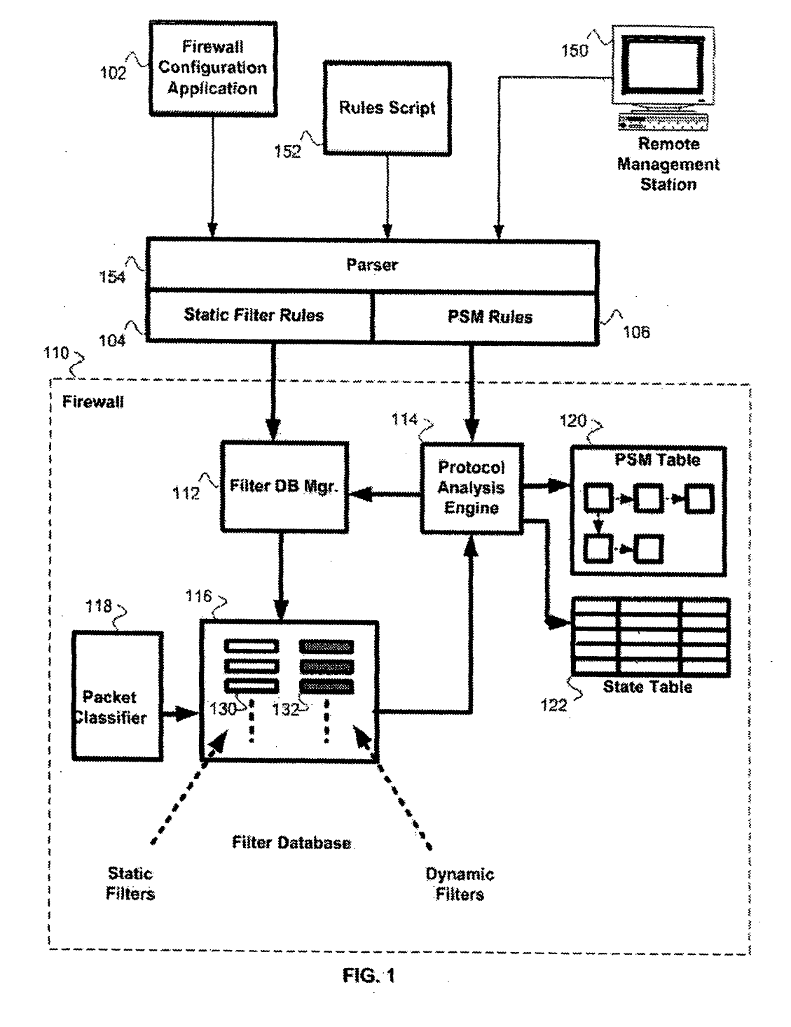

FIG. 1 is a block diagram of the major components of a hardware and software operating environment 100 incorporating various embodiments of the invention. The systems and methods of the various embodiments of the invention may be incorporated on any hardware or software system that can support network communications. Generally such hardware includes firewall systems, personal computers, server computers, mainframe computers, laptop computers, portable handheld computers, personal digital assistants (PDAs), network enabled cellular telephones, wireless base stations, routers, switches, network interface cards, baseboard management controllers and hybrids of the aforementioned devices. In some embodiments of the invention, operating environment 100 comprises a firewall configuration application 102 and firewall 110. Firewall configuration application 102 provides an interface to manage configurations for firewall 110. In some embodiments of the invention, the firewall configuration application manages a set of rules provided in a rules script. Firewall configuration application 102 may execute on the same computing system as firewall 110. Alternatively firewall configuration application 102 may execute on a computing system such as remote management workstation 150 that is remote from firewall 110 and communicably coupled to firewall 110 through a wired or wireless network.

Rules script 152 comprises a file or set of files that specify aspects of the operation of firewall 110. In some embodiments, these rules include static filter rules and Protocol State Machine (PSM) rules. It is desirable that rules script 152 be implemented in a non-proprietary language so that the rules in rules script 152 may be portable across firewalls provided by differing manufacturers. In some embodiments, rules script 152 is implemented using the XML (eXtensible Markup Language). In such embodiments, style sheets may be used to provide rule translations for differing firewalls. An exemplary rules script 152 that provides a specification of static filter rules and PSM rules for a context aware firewall where the context application is an active file transfer protocol is provided below in Appendix A.

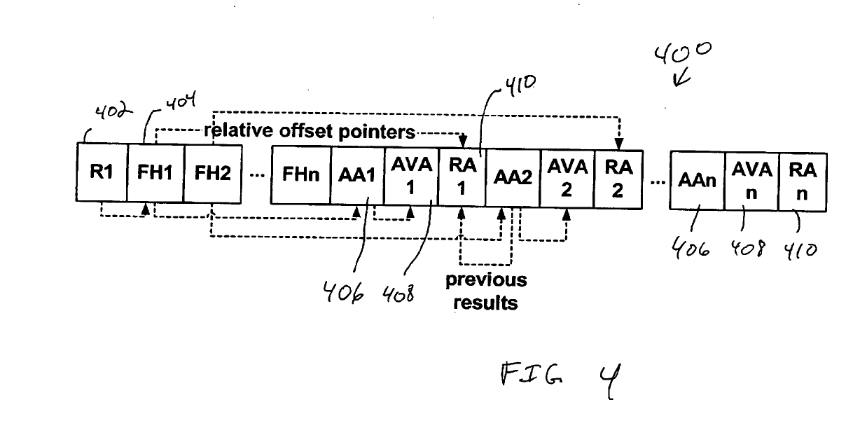

Parser 154 receives rules script 152 and parses the script into a binary format described below with reference to FIG. 4. In some embodiments, parser 154 parses the rules script into binary versions of static filter rules 104 and PSM rules 106. Parser 154 may be included as part of the configuration application or parser 154 may reside on firewall 110.

Static filter rules 104 and PSM rules 106 may be stored in persistent storage such as files, databases or other persistent storage means. In some embodiments, the rules are stored according to a protocol analysis engine 114 that may include rule names, rule types, conditions and actions that specify aspects of the expected behavior of the protocol. In some embodiments, a PSM rule may be expressed as a series of condition checks on packets, and a series of actions to be performed as a result of the checks.

The rule conditions and actions in static filter rules 104 and PSM rules 106 may include calls to intrinsic functions that operate on packets in a network flow. The packets are not limited to network layer packets (e.g. as defined by the OSI (Open System Interconnection) layer model), and may include packets defined at any level, including application layer packets. As an example, the intrinsic functions included in some embodiments of the invention include functions that perform one or more of the following: data extraction, string manipulation, math operations, filter management, state table management, pattern table management and packet-related utilities.

In some embodiments, the following intrinsics are exposed for data extraction:
ExtractFixedSizePattern: Extracts a fixed number of bytes from packet
ExtractVarSizePatternEnd: Extracts a pattern of variable length given end pattern and starting offset from given buffer
ExtractVarSizePatternBoth: Extracts a pattern of variable length given start and end patterns, from given buffer
   The rules script schema defines a content-rule complex type that contains the parameters for data extraction. This type has the following attributes:
CmpData: Data to be compared against
CmpMask: Mask to be applied before comparing
SetSymbol: Symbol in which data extracted is saved
PatternSpec: Name of pattern macro for reuse

In some embodiments, the following intrinsics are exposed for string operations:
ExtractRight/LeftSS: Extracts a substring of variable length to right of given start offset from buffer
TokenizeString/Packet: Tokenizes the buffer with the set of characters specified in the delimiter starting at given offset.
StrCmp: Used to perform string comparison operation on the two buffers
   The configuration parameters in the rules script schema for the ExtractRight/LeftSS element are:
StartPos: Offset in operand string to extract from
Direction: Direction in which to extract
ResArraySymbol: Array symbol to store results
ParamData: The operand string; this is a constant, a pattern specification or a symbol.
   The configuration parameters in the rules script schema for the tokenizer element are:
TokenizePacketData/TokParamSymbol: Complex type which holds either packet data extraction parameters or a symbol name which must hold saved data or a constant
Separators: Array of separators to tokenize data
ResArraySymbol: Symbol to store tokenized results
   The configuration parameters for the strcmp element are the string operands to be compared.

In some embodiments, the following intrinsics are exposed for math operations:
MathOpUint8/16/32/64: Binary arithmetic operation on unsigned 8/16/32 or 64 bit integral values
ApplyBitwiseOp: Performs bitwise operation on the 32 bit value using the specified mask Val.
   Expression is a rules script schema complex type that contains the parameters for math operations. The configuration options for this type in the schema are:
Operands: Complex type which holds either packet data from extraction or symbol names
Operator: Operator type
SetExprResult: Symbol name which holds the result of the expression

In some embodiments, the following intrinsics are exposed for Filter management:
AddDynamicFilter: Used to add a dynamic policy with the specified filter value.
RemoveDynamicFilter: Used to remove a dynamic policy with the specified filter value.
   The configuration options for the dynamicfilter complex type are:
UseFlowId: The flow id symbol that holds the unique identifier created using the filter 5-tuple. The filter parameters are in the computeflowid complex type referenced by this element. The computeflowid type computes a hash based on the flow 5-tuple.
ReturnProtocolId: The identifier to be returned if a subsequent packet matches this filter
ReverseFlow: Flag to specify if the filter should be installed for the reverse flow

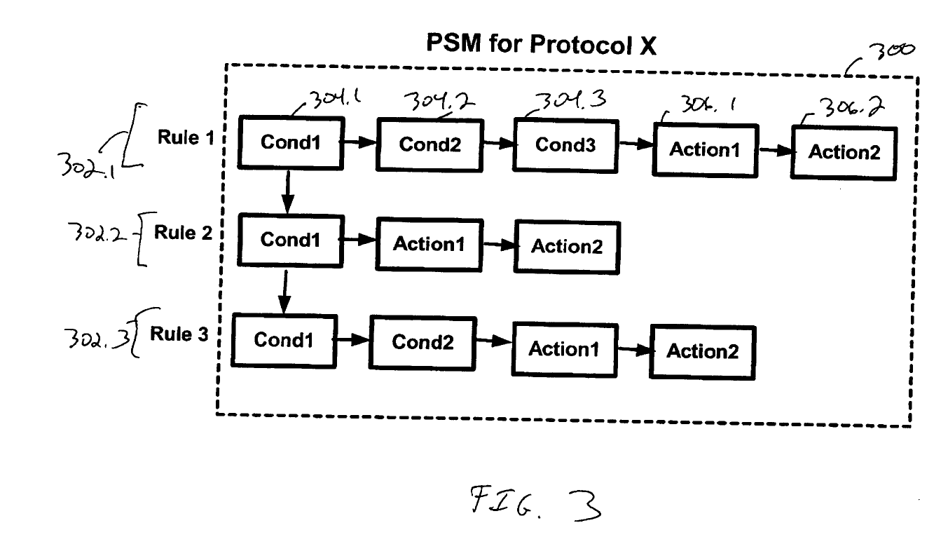

In some embodiments, the following intrinsics are exposed for state table management:
ComputeFlowId: Used to compute a unique identifier for the packet flow based on specified extracted fields of the packet. The algorithm used to compute the ID is pre-defined (Example: XOR of the header fields of the packet header)
Create/DeletePerFlowStateTable: Creates (or Deletes) a per-flow state table that tracks per-flow state information of recently seen flows
Get/SetFlowState: Retrieves (or updates) flow state information corresponding to a flow that is being tracked by the flow state table
Define/GetContextData: Defines context data corresponding to a flow. The context data can be subsequently retrieved using the GetContextData function
   Configuration options for the createtable type are:
TableColType: An array of table column type, each of which has the following attributes: Column Name, Column Type, Part-Of-Index flag, and default value
TableId: Unique id for state table
Timeout: Timeout value for the table entries
   The complex type for Get/SetFlowState either returns a flow state or sets the supplied state in the state table. States are further described below with reference to FIG. 3. The complex type for Define/GetContextData is a protocol specific data object.

In some embodiments, the following intrinsics are exposed for Pattern table management:
Create/DeletePatternTbl: Creates (or deletes) a pattern table that holds patterns (example: protocol key-words) that can be searched for in an incoming/outgoing packet
Insert/DeleteIntoPatternTbl: Updates (inserts/deletes) a pattern table
FindPatternFromPatternTbl: Search for a pattern in pattern table
The configuration parameters in the rules script for this capability are in the content-rule complex type:
CmpData: Pattern to be stored in the pattern table
PatternTable: Name of pattern table to store pattern

In some embodiments, the following intrinsics are exposed as packet related utilities:
DropPacket: Used to deallocate packet buffer and prevent it from further network traversal
CreatePacket: Creates a new packet buffer with specified fields. Useful when firewall implemented as a proxy or to generate alert messages
CopyPacket: Make a copy of a given packet
RedirectPacket: Redirect packet to a different processing module instead of sending it through the network stack

In addition to the above-described functions, some embodiments of the invention support the following actions:
Outsource a flow or hold/resume a flow
Mark packets
Install/Remove/(De)activate rules based on packet contents or events

It should be noted that the above described functions and actions are examples of functions and actions that may be included in various combinations in various embodiments of the invention. No embodiment of the invention is limited to those functions and actions detailed above.

Additionally, the rules script schema elements described above may be arranged under policyrule and policyaction complex types. Autonomic-configuration may be achieved by including the policyrule complex type as one of the possible attributes of the policyaction type.

In some embodiments, firewall 110 includes a filter DB manager 112, a protocol analysis engine (PAE) 114, a filter database 116, a packet classifier 118. Each of these components may have an API or other interface. The firewall configuration application 102 passes the PSM information and packet filter details to the PAE 114 and filter DB manager 112. As noted above, the firewall configuration application 102 may send the rules as binary data formatted as described below with reference to FIG. 3. The filter DB manager 112 manages the binary formatted static rules that come in through the firewall configuration manager 102 and the dynamic rules that are configured by the PAE 114.

The filter database 116 holds the set of static 130 and dynamic filters 132 according to which packets are first classified. Static filters 130 remain in the filter database until explicitly removed by the administrator. They are not expected to be modified or deleted frequently and generally apply to aggregate flows, for example all TCP flows, all FTP flows etc. Dynamic filters 132 on the other hand are added and deleted by the PAE 114. In some embodiments, dynamic filters 132 operate to perform various filtering tasks, which may include tracking per flow state changes, gathering statistics and otherwise providing fine grain access control to individual network flows. Dynamic filters 132 are typically relatively short-lived since they represent transient flows, e.g. application sessions that come and go as network applications are started and stopped (e.g. ephemeral FTP data sessions). The static and dynamic filters provide the first level of filtering that prevents every packet from going through the more intensive stateful processing by the PAE 114.

In some embodiments, PAE 114 performs a second level of packet filtering that may be context-aware. The PAE 114 may be configured with a set of one or more Protocol State Machines (PSMs) in the PSM table 120 that dictate the manner in which the packets are processed. In some embodiments, PAE 114 tracks the per-flow state, statistics and context information for each managed network flow in the per-flow state table 122.

In some embodiments, a PSM in PSM 120 is generally implemented as a DFA (Deterministic Finite Automaton), and typically has a start state, one or more intermediate states and possibly more than one terminating, states. A flow belonging to any application protocol may be initiated, created and terminated typically after some data exchange. Upon an error condition, the flow may transition to an abort state. In other words, at a coarse grain level, a flow typically has an initialization phase, connection establishment phase, data exchange phase and connection termination phase. However, no embodiment of the invention is limited to any particular combination of phases or particular types of phases.

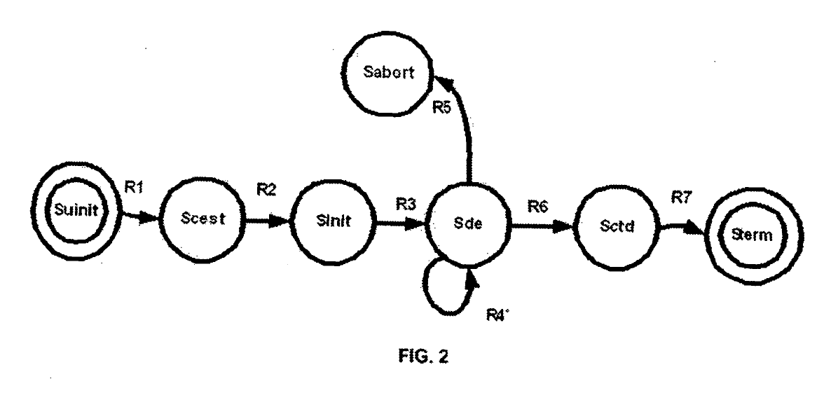

FIG. 2 illustrates an exemplary protocol state machine 200 with seven coarse grain states. R1 to R7 are the conditions/rules that cause the PSM to transition from one state to another. In the example provided in FIG. 2, the seven states are Suinit (Un-initialized), Sinit (Initialized), Scest (Connection Established), Sde (Data Exchange), Sctd (Connection Termination), Sterm (Termination), and Sabort (Abort). The seven states used above are a typical set of state transitions a flow goes through. However, a protocol PSM may have more or fewer than these seven states.

FIG. 3 is an illustration of an exemplary PSM having three rules 302.1, 302.2 and 302.3. In some embodiments, a PSM is an ordered list of rules 302. Each rule 302 is represented as a series of conditions 304 followed by a set of actions 306, which may be used to determine the state transitions. A group of such rules 302 may be used to define a PSM of a given protocol. In some embodiments, the order of the rules may be significant because it governs state transitions. Every successfully executed PSM rule can change the state of the flow.

In some embodiments, an individual PSM rule 302 is successfully applied (e.g. evaluates to TRUE) to a packet only if all conditions and actions have been executed. In some embodiments, once a rule is applied, the remaining rules of the PSM are not evaluated. In such embodiments, there is an implicit AND operation between the condition blocks 304 of a rule 302 and an OR operation between the individual rules 302 of a PSM. However, in alternative embodiments, logical AND and OR operations may be explicitly provided in the rules script. The condition blocks 304 of a rule evaluate to TRUE or FALSE. In some embodiments, a condition is executed only if the previous condition block returns TRUE (excluding the first condition which is unconditionally executed). Examples of conditions include, checking if a flow is in a particular state, determining if the protocol is of specified type, checking for specific TCP flags and so on. Examples of actions include: updating the flow state in the state table, adding/deleting a dynamic filter to the filter database, dropping a packet, modifying the IP TOS field etc.

In some embodiments, PAE 114 implements a set of low level intrinsic functions that are generic enough to be used as building blocks to express a wide range of actions and conditions. This is desirable as it allows the PAE 114 to be flexible to handle new PSMs without any changes to the firewall software itself. For example, if a policy requires: “Check if the source IPv4 address is equal to 10.10.10.20”, the policy may be broken into two basic functions in the PSM rules: 1) Extract 4 bytes at offset 27 from the start of the packet 2) Compare the extracted pattern with the network address 10.10.10.20.

FIG. 4 is a block diagram illustrating a data structure 400 for a binary format for a PSM rule according to embodiments of the invention. As described above, in some embodiments, the PAE 114 and filter database manager 112 expect the configuration application 102 to send the entire PSM rule set in a binary format. Thus the configuration application converts the high level script, which describes the PSM rules into a format, which expresses the function chain, an example of which was illustrated in FIG. 3. In some embodiments, an entire PSM block is sent to the PAE 114.

As illustrated in FIG. 4, the data structure 400 starts with a rule header 402, followed by a set of one or more function headers 404 and a set of one or more arrays containing details of function arguments 406 and results 410. In some embodiments, the data buffer for data structure 400 is a flat buffer with pointers replaced by offsets relative to the start of the buffer. In FIG. 4, FHx (Function Header) 404 represents the function descriptor, AAx (Attribute Array) 406 and AVAx (Attribute Value Array) 408 describe input arguments, and RAx (Results Array) 410 describes return values. A function block may represent a particular atomic intrinsic. Each function header, FHx 404 contains offsets that point to corresponding argument information contained in the Attribute Array, AAx 406. Each element in the Attribute Array 406 contains the type, length of the attribute and pointer (offset) to the actual value of the attribute, which is contained in the AVAx array 408. In addition, FHx 404 contains offsets that points to RAx 410. The offsets are indicated by the arrows in FIG. 4.

As noted above, function block FHx 404 may represent a particular atomic intrinsic for example, ExtractFixedLengthPatternFromPacket which is in turn is expressed as a set of attributes 406 (offset in packet, length of data to extract, whether to convert it into a specific format) and a set of result values 502, in this case, the extracted data after the function is executed.

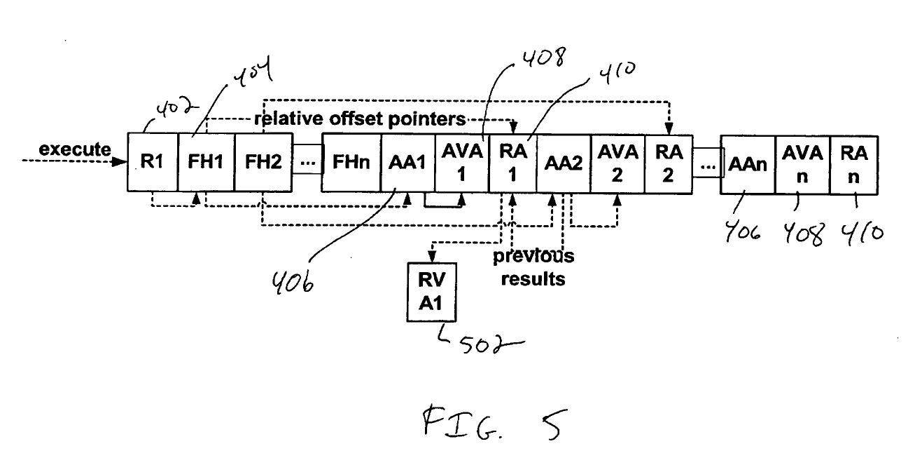

FIG. 5 illustrates an example of how a rule data structure 400 is used during the execution of a rule. When a packet is forwarded to the PAE 114 via the packet classifier 118, the PAE attempts to apply all rules of a PSM until the first matching rule is encountered. In some embodiments, after the first matching rule is found, no further rules are matched. More than one PSM may be applied to a packet. For example, when a packet corresponding to HTTP flow arrives at the PAE 114, PAE 114 will attempt to apply all rules of the TCP PSM followed by rules in the HTTP PSM. PAE 114 runs a PSM execution engine which starts executing the PSM rule by looking into the binary data, an example of which is as shown in FIG. 5.

During run-time, PAE 114 interprets function blocks and executes them in order. Results generated by a function block may be used as input to subsequent function blocks. In some embodiments, the execution engine looks into the first function header, and calls the function implementation with arguments extracted from the buffer. The results are placed in the RVA (Results value array) 502. For example, PAE 114 generates the result RVA1 after executing FH1. After execution of the function defined in FH1, AA2 points to RA1 and thus may be used as input to the function block FH2.

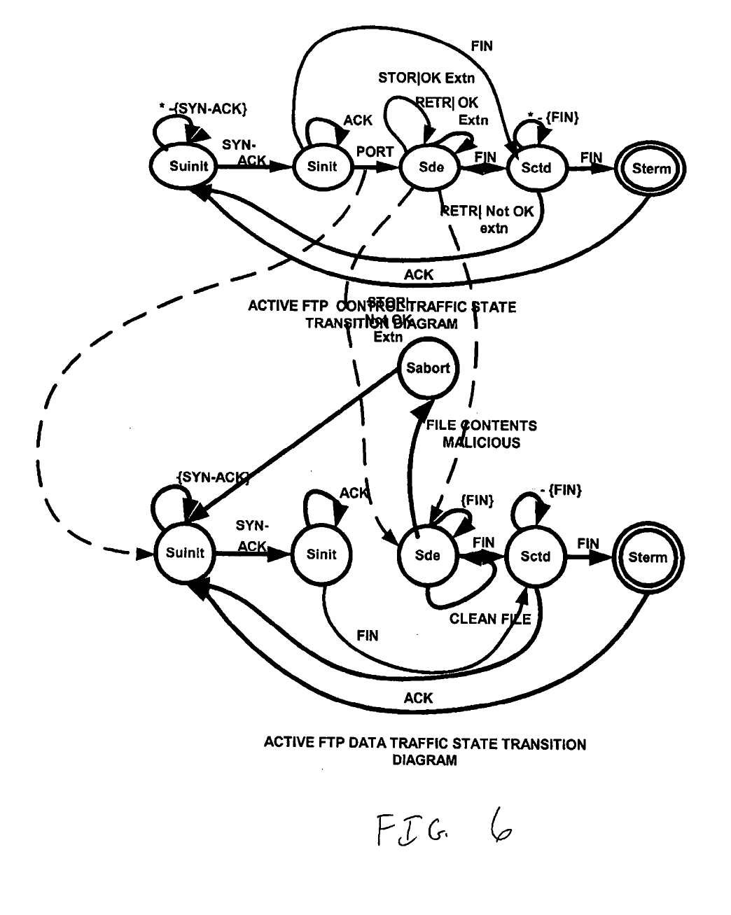

FIG. 6 illustrates the operation of a firewall 110 according to an embodiment of the invention for an exemplary AFTP (Active File Transfer Protocol) session. Note that although AFTP was selected for illustration purposes, more complex application layer protocols can be defined and tracked using the systems and methods of the embodiments of the invention. One of the more serious problems encountered using AFTP is the ability for a client to upload or download malicious, restricted or confidential material. AFTP is an interesting candidate protocol for stateful inspection as it uses a well-known port number for control information and opens up ephemeral ports for the actual data transfers. In order to avoid obscuring the example, only the subset of the state machine that pertains to file transfer tracking is discussed with respect to FIG. 6.

For purposes of the example illustrated in FIG. 6, the state transitions enable the following on the client:
Start tracking state only if the AFTP session is initiated by the client
By default, restrict all traffic other than AFTP control traffic
Create transient filters for the negotiated data flow.
On the negotiated port, access may be restricted to certain allowed FTP commands
While transferring files, suspicious file content (identified through a set of heuristics) may be scrutinized and malicious content may be blocked during data exchange before it reaches the application
All traffic that causes invalid protocol state transitions must be blocked proactively

As seen in FIG.6, separate state transition machines are specified for control and data channels. Certain events on the control channel (such as the arrival of the “PORT” command) can trigger state transitions on the data channel. This is indicated by the dotted line connecting the two state machines.

Appendix A provides an exemplary XML based script that defines the state transitions for an exemplary PSM for the AFTP state transitions described above. The PSM as defined by the script may be sent to the parser that translates it into the format expected by the PAE (as described with respect to FIGS. 4 and 5). The PAE then interprets the PSM and tracks the AFTP sessions as follows:
Every new flow is implicitly in the Suinit state. The arrival of a SYN-ACK packet at the client indicates that the FTP server is present and has accepted the connection. Hence, when a TCP packet with the SYN-ACK bits set is received, the flow transitions from the Suinit to the Sinit state
The AFTP “PORT” command is used to negotiate the data port to be used for the data exchange. When the “PORT” command is detected on the control channel, the control flow transitions from the Sinit to the Sde state wherein the negotiated data port is extracted and used for data exchange. The same command also takes the data channel (or flow) into the Suinit state
The AFTP “RETR” and “STOR” commands are used for retrieving and storing files respectively. When a “RETR” or a “STOR” command is detected on the control channel in the Sde state, a check is made to see if the file being transferred needs further scrutiny. This could be identified by specific file extensions, file names or other heuristics
If it is detected that the file contents need to be scanned, the data channel transitions from the Sinit to the Sde state. If the check determines that file contents need not be scanned, then the data channel continues to remain in the Sinit state
During the actual file transfer along the data channel, if the data channel is in the Sde state (implying that the file identified needs scrutiny), the file contents are scanned for malicious or restricted content (virus signatures or confidential material). This is done using appropriate content inspection or virus scanning software. If the scanning identifies the file content as malicious, then the file transfer is disallowed and the data flow transitions to the Sabort state
All file transfers that occur along the data channel in the Sinit state are passed without scrutiny. In this manner, the PSM does intelligent, heuristic-based, selective inspection of file contents
A TCP FIN packet received on the data or control channel takes the flow from the Sde to Sctd and then to the Sterm state (and subsequently into the Suinit state)

The software components running in the operating environment may be read from a machine-readable media and run under the control of an operating system, and interfaced with the operating system. Examples of such machine-readable media include hard disks, floppy disks, CD-ROMs, DVD-ROMs. Further, machine-readable media includes wired and wireless signals transmitted over a network. Examples of operating systems include Windows® 95,Windows 98®, Windows Me®, Windows CE®, Windows® NT, Windows 2000®, and Windows XP® by Microsoft Corporation. However, the embodiments of the invention are not limited to any particular operating system, and in alternative embodiments the software components may operate within the Palm OS® from Palm Inc., variants of the UNIX and Linux operating systems and cellular telephone operating systems.

Additionally, in varying embodiments the systems and methods of the present invention may be implemented in firmware.

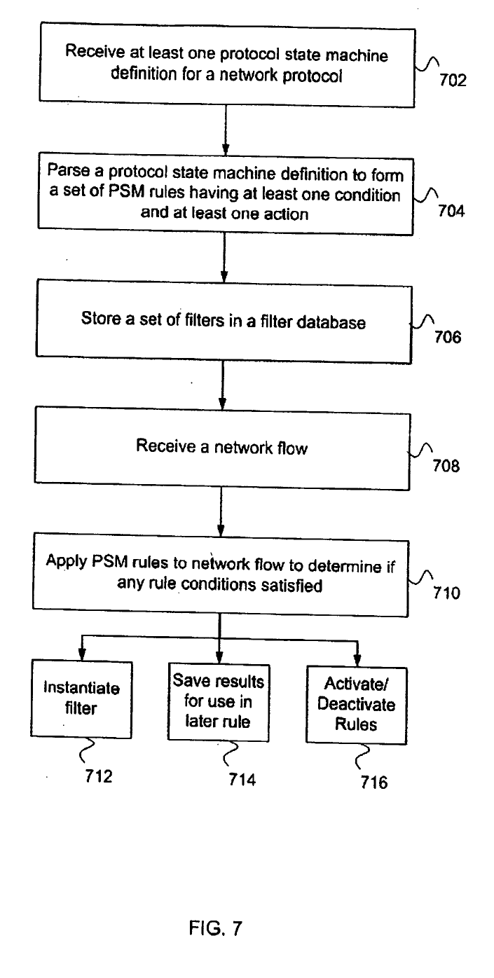

FIG. 7 is a flowchart illustrating methods for providing a context aware firewall according to embodiments of the invention. The methods may be performed within an operating environment such as that described above with reference to FIG. 1. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from computer-readable media such as RAM, ROM, CD-ROM, DVD-ROM, flash memory etc.). The methods illustrated in FIG. 7 are inclusive of the acts performed by an operating environment executing an exemplary embodiment of the invention.

The method begins when a system executing the method receives a definition for a PSM (block 702). As noted above, the definition may include rules expressed as conditions and actions. Further, the rules may be received in a text format and converted to a binary format, or in alternative embodiments the rules may be received in a binary format.

Next, the rules are parsed into a PSM (block 704). The PSM may be maintained as a table in a database.

Additionally, in some embodiments, a set of filters may be stored in a database of filters (block 706). As described above, the filters may be static filters or the filters may be dynamic filters.

Upon receiving an initiation of a network flow (block 708), a system executing the method proceeds to apply the PSM rules to the network flow (block 710). In some embodiments, the rules may be executed in order until a matching rule is found. In some embodiments, one or more conditions in the rule are used to determine if the rule matches. Upon a successful match, the rule action or actions are executed.

In some embodiments, an action may be the creation of a filter (block 712). As noted above, the filter may be a dynamic filter that may be removed by the PAE subsequently (for example, upon flow termination).

Further, the action may cause the results of the rule to be saved (block 714). The saved results may then be used by later executed rules for the same flow. This is desirable because it allows the context aware firewall to maintain an expected state and context for the network flow.

Additionally, the action may activate or deactivate rules in the PSM (block 716). The dynamic activation and deactivation of rules provides the ability for a context-aware firewall to be self-configuring and to adapt to new situations and protocols.

Those of skill in the art will appreciate that the functionality described above may be distributed across hardware and software in various manners. The method may be executed on the processor of a firewall system, a general purpose computer system, a personal computer, a laptop computer a server computer, a personal digital assistant, or a mainframe computer. Further, the method may be executed in whole or in part by a BIOS (Basic Input/Output System) or EFI (Extensible Firmware Interface) based platform firmware on a computer system. Still further, the method may be executed in whole or in part by an add-on card such as a wired or wireless network interface card. Yet further, the method may be executed within a chip or chipset. The embodiments of the invention are not limited to any particular distribution of functionality.

As can be seen from the above, the systems and methods provide an intrusion detection capability. Rules for A PSM may be defined that provides the ability for the PAE to check for conditions that detect that an intrusion is in progress.

Further, the systems and methods of the invention may be used to facilitate autonomic computing. Autonomic components typically anticipate computer system needs and resolve problems with minimal human intervention. Autonomic computing was conceived as a way to help reduce the cost and complexity of owning and operating an Information Technology (IT) infrastructure. In an autonomic environment, system components from hardware such as desktop computers and mainframes to software such as operating systems and business applications may be self-configuring, self-healing, self-optimizing and self-protecting.

“Self-Protection” is the ability to anticipate, detect, identify and protect against attacks from anywhere. Self-protecting components can detect hostile behaviors as they occur and take corrective actions to make themselves less vulnerable. The hostile behaviors can include unauthorized access and use, virus infection and proliferation, and denial-of-service attacks. Self-protecting capabilities allow businesses to consistently enforce security and privacy policies. The ability to provide PSM rules in a context aware firewall of some embodiments of the invention provide platform capabilities that may be self-protecting.

Additionally, the systems and methods of some embodiments of the invention may be used to implement a “circuit breaker”. A circuit breaker is typically a mechanism that may be used either by the platform or by remote administrators to disconnect the platform from the network, based on policy set by the platform administrators.

As an example of the circuit breaker mechanism on an embodiment of a context aware firewall, consider the following scenario:
An unknown issue affects platform OS which causes invalid behavior of OS which is no longer responsive and is sending invalid packets
The Administrator defined the PSM such that invalid protocol transitions should be counted and thresholds be checked.
The PSM of the context aware firewall 110 can be defined to program the NIC to disable transmit of network packets altogether or can stop this particular protocol via short-lived static filters.
Thus the platform can stop unknown attacks or anomalies until more information are available, which might require OS patches to be applied.

The systems and methods of the invention may be used for network visibility functions. This mechanism lets policy writers define fine granular, application specific, access control rules for the platform. These policies can be used to raise customizable alerts which when correlated give the administrators greater visibility into the network state. This mechanism also uses the application state available on the platform to perform more intelligent decisions and infer platform state.

For example, a context aware firewall of some embodiments exhibits network visibility by tracking downloads and uploads of files using a transfer protocol, for example AFTP. In this example assume a setup where a client is running a context aware firewall according to embodiments of the invention. A PSM may be defined with the following attributes:
Starts tracking state only if session initiated by client
Can restrict access on the negotiated port only (other ports not open)
Creates dynamic filters only for the negotiated flow. These filters exist only for the duration of the data session.
On the negotiated port, access can be restricted to certain FTP commands
Known malicious content can be blocked during data exchange before it reaches the application
Invalid state transitions (seen via flow packets) which could be caused due to undocumented vulnerabilities are blocked proactively

Systems and methods for providing a context aware firewall have been described. The various embodiments of the invention may provide advantages over previous systems. For example, the systems and methods of the various embodiments of the invention provide an architecture for a context aware platform firewall. There is typically a tradeoff between the amount of packet processing and performance. The impact is even more significant if application layer inspection is done at the perimeter of the networks where the volume of traffic to be inspected is significantly large compared to an end-point. The systems and methods of the invention are not restricted as to where they are implemented (infrastructure or end-point). Thus the impact of packet inspection on overall performance may be reduced at the end-point as compared to the infrastructure node. Additionally, the approach described uses flow state information and control payload to make intelligent decisions on what data packets it should subject to time consuming operations like deep packet inspection.

The systems and methods of embodiments of the invention may be extensible and programmable in order to accommodate new protocol definitions. The interfaces and PSM for configuring the context aware firewall may be defined in generic manner. The architectural framework typically includes one or more of the following attributes:
Protocol rules are parsed to binary format function blocks for direct execution by the firewall.
The context aware firewall is protocol agnostic and can be programmed to interpret new protocol definitions (available through PSMs) without requiring any changes in the firewall software.
The context aware firewall of some embodiments is capable of deriving and maintaining per flow state information that determines the actions that have to be applied on the packets

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

Appendix A: Rules Script (Partial) for AFTP Client

<?xml version=“1.0” encoding=“UTF-8”?>

| | |
|---|---|
| <!-- | INTEL CORPORATION PROPRIETARY INFORMATION --> |

<!-- This script is supplied under the terms of a license agreement or -->
<!-- nondisclosure agreement with Intel Corporation and may not be copied -->
<!-- or disclosed except in accordance with the terms of that agreement. -->
<!-- Copyright (c) 2003 Intel Corporation. All Rights Reserved. -->
<SafireRoot xmlns:xsi=“http://www.w3.org/2001/XMLSchema-instance”

xsi:noNamespaceSchemaLocation=” safire-lean-mean.xsd”>

<Statements Block-Name=“ftp-block” NumberOfGroups=“2”>

| <!-- ========================================================================--> | | | | | |
|---|---|---|---|---|---|
| <!-- | /\ | +=== | ==+== | /===\ | --> |
| <!-- | /==\ | /=== | / | /===/ | --> |
| <!-- | / \ | / | / | / | --> |

<!-- ========================================================================-->
<SAFireStmt Description=“AFTP PSM” NumberOfRules=“3”>

<CreateTable TableId=“1” Timeout=“120”/>
<DefineConstant ConstName=“PROTOCOL-ID-FTP” ConstType=“uint32” ConstValue=“1”/>
<Definepattern ConstOffset=“10” Type=“ASC”
Depth=“4” DataMask=“DFDFDFDF”
PatternSpecName=“FTPcommand4byte”/>
<DefineSymbol SymbolName=“sa” SymbolType=“uint38 SymbolFormat=“BIN”
IsArray=“false” ArrayLength=“1” NetworkOrder=“true”/>
<!-- Catch all to drop all traffic that is not analyzed by other filters -->
<StaticPolicy Id=“1” Description=“drop all tcp” Action=“Drop”>

<StaticPolicyField FieldType=“Protocol” Begin=“6”/>

</StaticPolicy>
<StaticPolicy Id=“2” Description=“out ftp control from client” Action=“Analyze”>

<StaticPolicyField FieldType=“DstPort” Begin=“21”/>
<StaticPolicyField FieldType=“Protocol” Begin=“6”/>

</StaticPolicy>
<StaticPolicy Id=“3” Description=“in ftp control from server” Action=“Analyze”>

<StaticPolicyField FieldType=“SrcPort” Begin=“21”/>
<StaticPolicyField FieldType=“Protocol” Begin=“6”/>

</StaticPolicy>
<ComplexPolicy>

<!-- ==================== RULE 1 =====================-->
<SimplePolicy Name=“aftp srm rule 1” Active=“true”>

<Association CapabilitysetName&=“AFTP-clients”/>
<ValidTimes/>
=SetupList>

<Extract PatternSpec=“IPv4SA” SetSymbol=“sa”/>
<Extract PatternSpec=“IPv4DA” SetSymbol=“da”/>
<Extract PatternSpec=“TCPSrcPort” SetSymbol=“sp”/>
<Extract PatternSpec=“TCPDstPort” SetSymbol=“dp”/>
<Extract PatternSpec=“IPv4Protocol” SetSymbol=“pr”/>
<ComputeFlowId SetFlowIdSymbol=“ftpctrlflowid”>

=CFID_SymbolName name=“sa”/>
=CFID_SymbolName name=“da”/>
=CFID_SymbolName name=“sp”/>
<CFID_SymbolName name=“dp”/>
<CFID_SymbolName name=“pr”/>

</ComputeFlowId>

</SetupList>
<RuleList>

<AndRules name=“check-ftp-outgoing”>

<Rule Direction=“out”>

<CheckState FlowTableId=“FTP-FLOW-TABLE” CheckState=“Sinit, Sde”

FlowIdSymbol=“ftpctrlflowid”/>

<Expr Operator=“r_eq”>

<Operands>

<Op_Symbol SymName=“ftp-control-port”/>
<Op_Symbol SymName=“dp”/>

</Operands>

</Expr>
<Function><GetSelfMac resSymbol=“selfmac”/></Function>
<Pattern PatternSpec=“srcmac” SetSymbol=“extsrcmac”/>
<Expr Operator=“r_eq”>

<Operands>

<Op_Symbol SymName=“extsrcmac”/>
<Op_Symbol SymName=“selfmac”/>

</Operands>

</Expr>
<Pattern CmpData=“PORT” ReturnIndex=“portoffset”/>

</Rule>

</AndRules>

</RuleList>
<ActionList Action=“allow”>

<Function>

<Tokenize Seperators=“,” ResArraySymbol=“strarray”>

<TokenizePacketData>

<TokPktFixedLenPattern SymOffset=“portoffset” Type=“ASC”

Depth=“999”/>

</TokenizePacketData>

</Tokenize>

</Function>
<Eval SetExprResult=“upperftpport” Operator=“b_lshf”>

<Operands>

<Op_Symbol SymName=“strarray” ArrayIndex=“4”/>
<Op_Symbol SymName=“leftshift”/>

</Operands>

</Eval>
<Eval SetExprResult=“ftpport” Operator=“m_add”>

<Operands>

<Op_Symbol SymName=“upperftpport”/>
<Op_Symbol SymNane=“strarray” ArrayIndex-“5”/>

</Operands>

</Eval>
<ComputeFlowId SetFlowIdSymbol=“ftpdataflowid”>

<CFID_SymbolName name=“sa”/>
<CFID_SymbolName name=“da”/>
<CFID_SymbolName name=“ftpport”/>
<CFID_SymbolName name=“ftp-data-port”/>
<CFID_SymbolName name=“tcpproto”/>

</ComputeFlowId>
<AddToTable FlowTableId=“FTP-FLOW-TABLE” SetState=“Suninit”

FlowIdSymbol=“ftpdataflowid”>

<AddTableIndexData ColName=“sa”/>
<AddTableIndexData ColName=“da”/>
<AddTableIndexData ColName=“ftpport”/>
<AddTableIndexData ColName=“ftp-data-port”/>
<AddTableIndexData ColName=“tcpproto”/>

</AddToTable>
<AddToTable FlowTableId=“FTP-FLOW-TABLE” SetState=“Sde”

FlowIdSymbol=“ftpctrlflowid”>

<AddTableIndexData ColName=“sa”/>
<AddTableIndexData ColName=“da”/>
<AddTableIndexData ColName=“sp”/>
<AddTableIndexData ColName=“dp”/>
<AddTablelndexData ColName=“pr”/>

</AddToTable>
<DynamicFilter FlowTableId=“FTP-FLOW-TABLE” UseFlowId=“ftpdataflowid”

ReturnProtocolId=“PROTOCOL-ID-FTP” ReverseFlow=“false”/>

<DynamicFilter FlowTableId=“FTP-FLOW-TABLE” UseFlowId=“ftpdataflowid”

ReturnprotocolId=PROTOCOL-ID-FTP“ ReverseFlow=“true”/>

<DefineContextData FlowTableId=“FTP-FLOW-TABLE“ FlowId=“ftpctrlflowid”>

<CtxtDataDefn MemberNumber=“1” MemberType=“uint16”

MemberDesc=“ephemeral ftp port”/>

</DefineContextData>
<SetContext FlowTableId=“FTP-FLOW-TABLE” FlowId=“ftpctrlflowid”>

<SetContextDataMember MemberNum=“1” MemberVal=“ftpport”/>

</SetContext>

</ActionList>

</SimplePolicy>

</ComplexPolicy>

</SAFireStmt>

</Statements> </SafireRoot>

1. A method comprising:
receiving at least one protocol state machine definition for a network protocol, said protocol state machine definition including a plurality of protocol state rules;
parsing the at least one protocol state machine definition to form a set of parsed protocol state rules, said parsed protocol state rules including at least one condition and at least one action associated with the condition;
storing a set of filters in a filter database;
receiving a network flow, said flow including a plurality of packets; and
applying the parsed protocol state rules to the plurality of packets in the network flow;
wherein the at least one action comprises the instantiation of a filter from the set of filters.

2. The method of claim 1, wherein the protocol state rules include rules for analyzing a context for the network flow.

3. The method of claim 2, wherein the context for the network flow includes an application layer context.

4. The method of claim 1 wherein the filter comprises a dynamic filter that is instantiated for the duration of the network flow.

5. The method of claim 1, wherein the filter comprises a static filter that is applied during an initiation of the network flow.

6. The method of claim 1, wherein the at least one action comprises saving the result of the at least one action for use in a later executed rule in the set of parsed protocol state rules.

7. The method of claim 1, wherein the at least one action comprises deactivating a rule in the set of parsed protocol state rules.

8. The method of claim 1, wherein the at least one action comprises activating a rule in the set of parsed protocol state rules.

9. A system comprising:
a parser operable to parse at least one protocol state machine definition for a network protocol to a set of parsed protocol state rules, said protocol state machine definition including a plurality of protocol state rules, said parsed protocol state rules including at least one condition and at least one action associated with the condition;
a filter database operable to store a set of filters in a filter database; and
a protocol analysis engine operable to receive a network flow, said flow including a plurality of packets; and apply the parsed protocol state rules to the plurality of packets in the network flow;
wherein the at least one action comprises the instantiation of a filter from the set of filters.

10. The system of claim 9, wherein the protocol state rules include rules to analyze a context for the network flow.

11. The system of claim 10, wherein the context for the network flow includes an application layer context.

12. The system of claim 9 wherein the filter comprises a dynamic filter that is instantiated for the duration of the network flow.

13. The system of claim 9, wherein the filter comprises a static filter that is applied during an initiation of the network flow.

14. The system of claim 9, wherein the at least one action comprises saves the result of the at least one action for use in a later executed rule in the set of parsed protocol state rules.

15. The system of claim 8, wherein the at least one action deactivates a rule in the set of parsed protocol state rules.

16. The system of claim 9, wherein the at least one action comprises activates a rule in the set of parsed protocol state rules.

17. The system of claim 9, wherein the protocol analysis engine is further operable to maintain a state table for the network flow.

18. A machine readable medium having machine executable instructions for performing a method comprising:
receiving at least one protocol state machine definition for a network protocol, said protocol state machine definition including a plurality of protocol state rules;
parsing the at least one protocol state machine definition to form a set of parsed protocol state rules, said parsed protocol state rules including at least one condition and at least one action associated with the condition;
storing a set of filters in a filter database;
receiving a network flow, said flow including a plurality of packets; and
applying the parsed protocol state rules to the plurality of packets in the network flow;
wherein the at least one action comprises the instantiation of a filter from the set of filters.

19. The machine readable medium of claim 18, wherein the protocol state rules include rules for analyzing a context for the network flow.

20. The machine readable medium of claim 19, wherein the context for the network flow includes an application layer context.

21. The machine readable medium of claim 18 wherein the filter comprises a dynamic filter that is instantiated for the duration of the network flow.

22. The machine readable medium of claim 18, wherein the filter comprises a static filter that is applied during an initiation of the network flow.

23. The machine readable medium of claim 18, wherein the at least one action comprises saving the result of the at least one action for use in a later executed rule in the set of parsed protocol state rules.

24. The machine readable medium of claim 18, wherein the at least one action comprises deactivating a rule in the set of parsed protocol state rules.

25. The machine readable medium of claim 18, wherein the at least one action comprises activating a rule in the set of parsed protocol state rules.
